(19) United States
(12) Patent Application Publication
(10) Pub. No.: US 2005/0226790 A1
(43) Pub. Date: Oct. 13, 2005

(54) Flue gas treating equipment

(76) Inventors: Byoung-sup Park, Tokyo (JP); Bingzhe Jin, Tokyo (JP)

Correspondence Address: TOWNSEND & BANTA;c/o PORTFOLIO IP, PO BOX 52050, MINNEAPOLIS, MN, 55402, US

(21) Appl. No.: 10/514,945

(22) PCT Filed: May 30, 2003
(86) PCT No.: PCT/JP03/06862

§ 371 Date: Nov. 18, 2004

(30) Foreign Application Priority Data
May 30, 2002 (JP) 2002-156881

(51) Int. Cl. B01D 53/34; F23J 3/02; B08B 9/027

(52) U.S. Cl. 422/173; 422/210

(57) ABSTRACT

It is an object of the present invention to provide an exhaust gas processing apparatus capable of more effectively scraping off powder which is attached to an inner surface of a combustion chamber, and capable of increasing lifetime of an impact member which generates an impact against a scraping member. The exhaust gas processing apparatus is characterized in that a blade portion or an acute edge portion 7a1 is provided on a lever 7a which is a scraping member at a position opposed to an inner surface of a combustion chamber 1. The scraping member moves in a circumferential direction along the inner surface of the combustion chamber 1 to scrape off powder which is attached to the inner surface of the combustion chamber 1.

### TECHNICAL FIELD

The present invention relates to an exhaust gas processing apparatus for burning exhaust gas which is used and discharged during production of semiconductors and which includes flammable gas component and burning gas component, thereby rendering the exhaust gas harmless.

### BACKGROUND ART

It is known that harmful exhaust gas such as silane (SiH4), disilane (Si2H6), diborane (B2H6), phosphine (PH3), arsine (AsH3) and nitrogen trifluoride (NF3) is produced during the producing procedure of semiconductors. Since such toxic exhaust gas is highly harmful to human body, it is required to completely remove the toxic material when the exhaust gas is discharged into atmosphere.

Exhaust gas of flon gas which affects global environment such as carbon tetrafluoride (CF4) is produced in other particular procedure in the semiconductor producing procedure. It is required to eliminate such exhaust gas when discharged into atmosphere.

For example, Japanese Patent No. 2963792 proposes a processing method and a processing apparatus of toxic exhaust gas capable of satisfying the above requirement by burning the exhaust gas to render the exhaust gas harmless and then discharging the exhaust gas.

According to this technique, the exhaust gas is introduced into a cylindrical combustion chamber whose one end is closed, the exhaust gas is decomposed by high temperature generated when fuel such as hydrogen, methane, ethane, propane and butane is burned by a burner disposed in the combustion chamber or the exhaust gas is burned by the effect of stabilizing air, thereby rendering the exhaust gas harmless and then, the exhaust gas is discharged from a combustion gas transfer passage.

According to the exhaust gas processing apparatus having the above-described configuration, as the exhaust gas is burned, solid components included in various exhaust gases are generated in the form of powder. Most of powder is collected by a scrubber provided in the combustion gas transfer passage after the powder is discharged from the combustion section into the combustion gas transfer passage, but a portion of the powder attaches to an inner surface of a cylindrical body constituting an exhaust gas supply passage and a combustion section and remains thereon.

For example, when powder is generated in a combustion chamber and the powder is accumulated on the cylindrical inner surface constituting the exhaust gas supply passage and the combustion section, this adversely affects the flow and the combustion state of the exhaust gas, and there is an adverse possibility that the toxicity eliminating performance is deteriorated. Thus, maintenance for removing the powder, and this fact deteriorates the efficiency.

In order to efficiently remove the powder, there is an idea that a scraper is provided in a cylindrical body, a portion of the cylindrical body constitutes a combustion chamber, the scraper moves along an inner surface of the cylindrical body in its circumferential direction such that the scraper is in contact with the inner surface, the scraper is operated from outside so that the scraper rotates along the inner surface of the cylindrical body, thereby scraping off the power attached to the inner surface of the cylindrical body.

When combustion gas, stabilizing air or combustion gas cooling air is introduced, the power scraped off from the inner surface of the cylindrical body by the scraper can be discharged out through the combustion gas transfer passage by flow of the air.

As described above, the powder attached to the inner surface of the cylindrical body can be scraped off by the scraper and can be discharged out. However, when the scraper is a flat bar, since a surface thereof which scrapes off powder attached to the inner surface of the cylindrical body is substantially perpendicular to the inner surface of the cylindrical body, the powder can not be scraped off effectively, and there is a problem that the power attaches to the inner surface of the cylindrical body strongly.

In order to allow power attached to the scraper itself to fall, a leaf spring is used to bend the scraper to generate impact. However, when the fixing location of the leaf spring is a point or line contact, there is a problem that when the leaf spring is bent, the fixing location is prone to be folded.

Since one side of the scraper is supported, it is difficult to scrape the powder in a state in which a tip end of the scraper is reliably in contact with the inner surface of the cylindrical body. Therefore, it is required to scrape off the powder in a state in which the scraper is reliably in contact with the inner surface of the cylindrical body in an axial direction.

### DISCLOSURE OF THE INVENTION

The present invention has been accomplished to solve the above problems, and it is a first object of the invention to provide an exhaust gas processing apparatus capable of more effectively scraping off powder which is attached to an inner surface of a combustion chamber, and capable of increasing lifetime of an impact member which generates an impact against a scraping member. It is a second object of the invention to provide an exhaust gas processing apparatus capable of scraping off powder in a sate in which the scraping member is reliably in contact with the inner surface of the combustion chamber over a direction in which exhaust gas passes through the combustion chamber.

To achieve the above object, the present invention provides an exhaust gas processing apparatus comprising a combustion chamber and a combustion gas transfer passage, in which one end of the combustion chamber is closed and the other end thereof is connected to the combustion gas transfer passage, an exhaust gas supply passage is disposed on the side of the closed end, a burner is disposed closer to the combustion gas transfer passage than the exhaust gas supply passage, exhaust gas supplied to the combustion chamber is heated to a high temperature and decomposed or burned, and the exhaust gas is discharged from the combustion gas transfer passage, wherein the exhaust gas processing apparatus further comprises a scraping member which moves in a circumferential direction along an inner surface of the combustion chamber to scrapes off powder which is attached to the inner surface of the combustion chamber, the scraping member comprises a lever whose one end of the scraping member is mounted on a driving member provided outside of the combustion chamber and the other end is formed as a free end, a blade portion or an acute edge portion is provided on the lever at a position opposed to the inner surface of the combustion chamber.

According to the invention, the apparatus includes the combustion chamber which decomposes and burns the exhaust gas supplied from the exhaust gas supply passage at high temperature by the flame of the burner, and the combustion gas transfer passage. The exhaust gas supply passage is disposed on the closed end side of the combustion chamber, and the burner is disposed closer to the combustion gas transfer passage than the exhaust gas supply passage. Therefore, the exhaust gas supplied from the exhaust gas supply passage can be burned and decomposed by the burner, and the combustion gas can be discharged from the combustion gas transfer passage.

The blade portion or the acute edge portion is provided on the lever constituting the scraping member at the position opposed to the inner surface of the combustion chamber. Thus, the surface of the lever which scrapes off the powder can have the acute angle with respect to the inner surface of the combustion chamber. With this, the scraping member can effectively scrape off the powder attached to the inner surface of the combustion chamber, and the inside of the combustion chamber can be cleaned.

The apparatus has an impact member for generating an impact against the scraping member, and a plurality of leaf springs overlapped on one another with steps therebetween for generating an impact as the impact member bends the lever when the impact member comes into contact with the lever and the lever is returned to its original shape when the contact is released. With this, the stress applied to the leaf spring can be made surface contact and with this, the stress applied to the leaf spring can be moderated and the bending can be prevented, and the lifetime of the impact member can be increased.

According to the exhaust gas processing apparatus having the above-described configuration, when the scraping member (“scraper”, hereinafter) is operated by the driving member, the lever constituting the scraper comes into contact with the impact member and bending is generated in the lever, and as the contact with respect to the impact member is released, the bent lever is restored to its initial shape. Accordingly, an impact is generated, and powder attached to the lever can be scraped off.

The present invention also provides an exhaust gas processing apparatus comprising a combustion chamber and a combustion gas transfer passage, in which one end of the combustion chamber is closed and the other end thereof is connected to the combustion gas transfer passage, an exhaust gas supply passage is disposed on the side of the closed end, a burner is disposed closer to the combustion gas transfer passage than the exhaust gas supply passage, exhaust gas supplied to the combustion chamber is heated to a high temperature and decomposed or burned, and the exhaust gas is discharged from the combustion gas transfer passage, wherein the exhaust gas processing apparatus further comprises a scraping member for scraping off powder attached to an inner surface of the combustion chamber, the scraping member can move in a direction in which the exhaust gas flows through the combustion chamber along the inner surface of the combustion chamber by a driving member provided outside of the combustion chamber.

With this configuration, the scraping member can move in the direction in which the exhaust gas flows through the combustion chamber along the inner surface of the combustion chamber by the driving member provided outside of the combustion chamber. Therefore, the scraping member can scrape off powder along the inner surface of the combustion chamber in a state in which the scraping member is reliably in contact with the inner surface in the direction in which the exhaust gas flows through the combustion chamber, and powder strongly attached to the inner surface of the combustion chamber can easily be scraped off and removed.

### BRIEF DESCRIPTION OF THE DRAWINGS

FIG. 1 is a perspective explanatory view showing a configuration of a first embodiment of an exhaust gas processing apparatus according to the present invention;

FIG. 2(a) is a front view showing a configuration of a scraping member of the first embodiment, FIG. 2(b) is a plan view showing the configuration of the scraping member of the first embodiment, FIG. 2(c) is a left side view showing the configuration of the scraping member of the first embodiment and FIG. 2(d) is a right side view showing the configuration of the scraping member of the first embodiment;

FIG. 3 an explanatory view of an angle of a blade portion or an acute edge portion of the scraping member of the first embodiment;

FIG. 4 is a sectional explanatory view showing a configuration of an impact member of the first embodiment; and

FIG. 5 is a perspective explanatory view showing a configuration of a second embodiment of the exhaust gas processing apparatus of the invention.

### BEST MODE FOR CARRYING OUT THE INVENTION

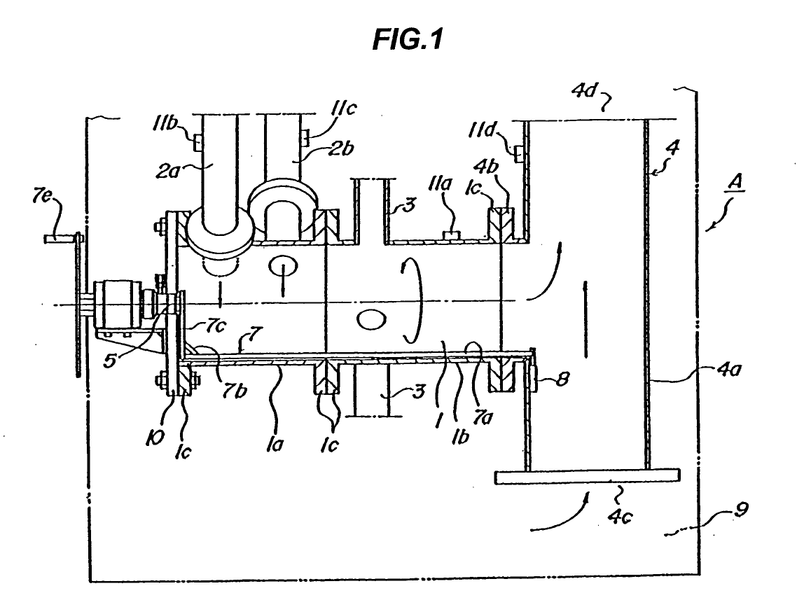

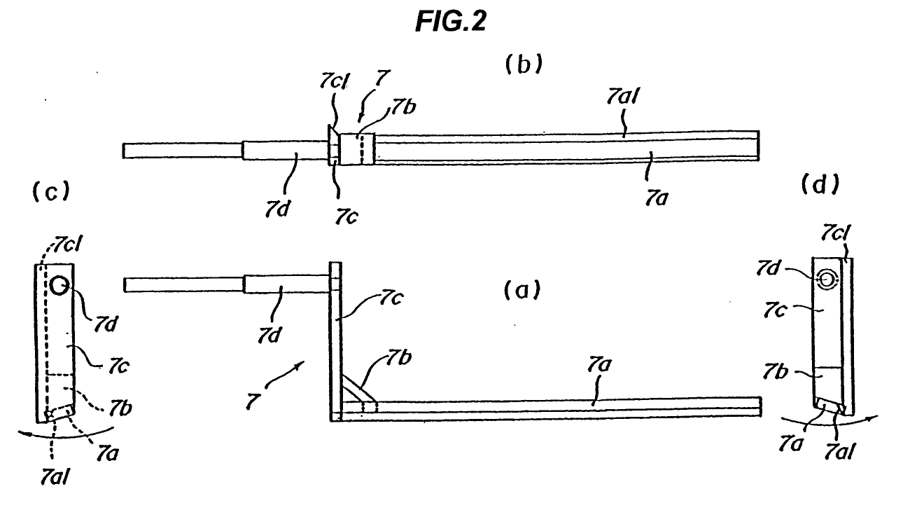

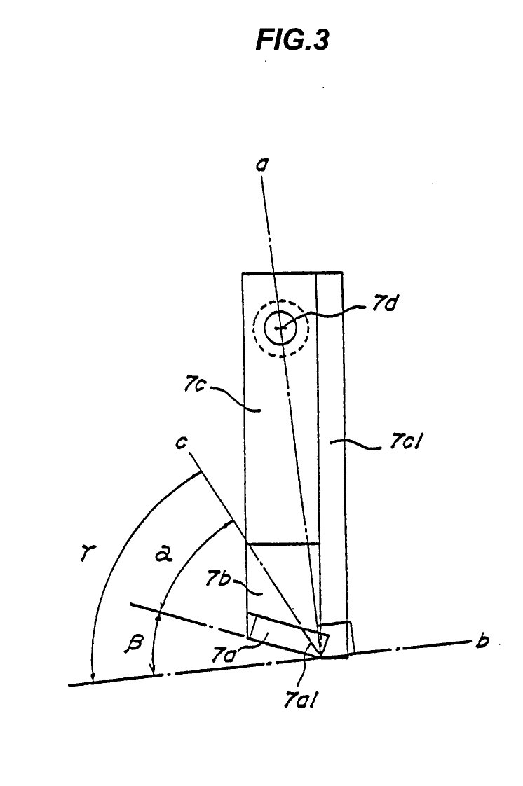

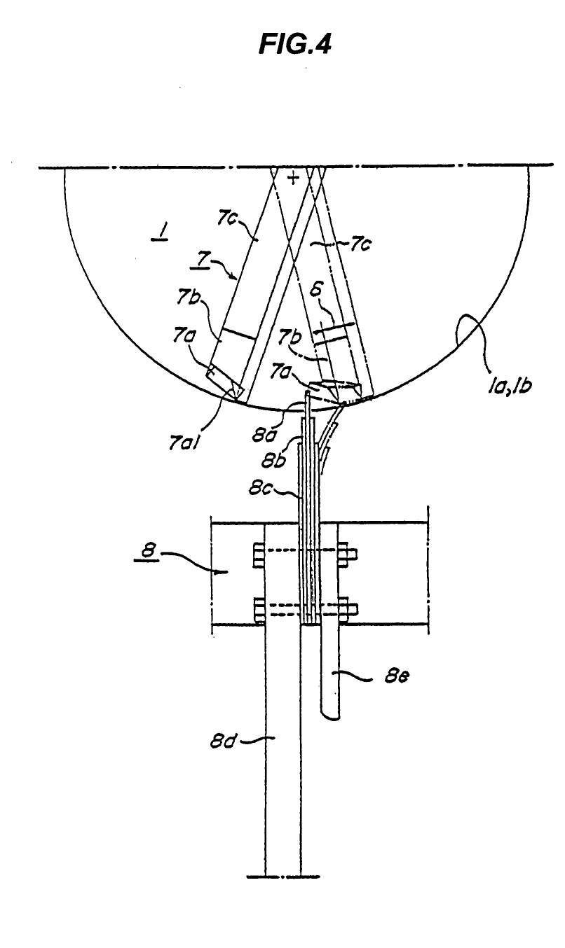

One embodiment of an exhaust gas processing apparatus of the present invention will be explained concretely using the drawings. FIG. 1 is a perspective explanatory view showing a configuration of a first embodiment of an exhaust gas processing apparatus according to the present invention. FIG. 2(a) is a front view showing a configuration of a scraping member of the first embodiment, FIG. 2(b) is a plan view showing the configuration of the scraping member of the first embodiment, FIG. 2(c) is a left side view showing the configuration of the scraping member of the first embodiment and FIG. 2(d) is a right side view showing the configuration of the scraping member of the first embodiment. FIG. 3 is an explanatory view of an angle of a blade portion or an acute edge portion of the scraping member of the first embodiment. FIG. 4 is a sectional explanatory view showing a configuration of an impact member of the first embodiment.

A configuration of a first embodiment of the exhaust gas processing apparatus according to the invention will be explained using FIGS. 1 to 4. In FIG. 1, the exhaust gas processing apparatus A has a function for completely burning or decomposing special material gas having toxicity such as silane, disilane, diborane, phosphine, arsine and nitrogen trifluoride produced during producing procedure of semiconductors, or exhaust gas such as flon gas which adversely affect the global environment such as carbon tetrafluoride, thereby rendering the gas harmless and discharging the gas.

The exhaust gas processing apparatus A includes a combustion chamber 1 which decomposes and burns exhaust gas supplied from one end of the exhaust gas processing apparatus A, exhaust gas supply passages 2a and 2b which are disposed on the side of one end of the combustion chamber 1 and to which exhaust gas to be processed is supplied, a burner 3 disposed downstream from the exhaust gas supply passages 2a and 2b in the combustion chamber 1, a combustion gas transfer passage 4 connected to the other end of the combustion chamber 1, a scraper 7 which is a scraping member provided in the combustion chamber 1 and which comprises a lever, and an impact member 8 which generates an impact against the scraper 7.

The combustion chamber 1 comprises cylindrical bodies 1a and 1b. The cylindrical bodies 1a and 1b are connected to each other by means of a bolt through flanges 1c such that a scraping member is interposed therebetween. A lid body 10 is fixed to the flange 1c provided on one end of the cylindrical body 1a by means of the bolt through the seal member to close the combustion chamber 1. The other flange 1c provided on the other end of the cylindrical body 1b is connected to a flange 4b of a T-shaped cylindrical body 4a constituting the combustion gas transfer passage 4 by means of the bolt, and is opened.

Exhaust gas supply passages 2a and 2b are disposed at predetermined positions of the cylindrical body 1a on the side of the lid body 10 of the combustion chamber 1. One or more burners 3 are disposed on the cylindrical body 1b on the side of the combustion gas transfer passage 4 which is downstream from the exhaust gas supply passages 2a and 2b. A temperature sensor 11a is provided between the burner 3 and the combustion gas transfer passage 4, and the temperature sensor 11a detects the temperature in the combustion chamber 1.

The exhaust gas supply passages 2a and 2b are connected to exhaust gas generating member (not shown) (e.g., processing apparatuses which constitute producing procedure of semiconductors), and the exhaust gas supply passages 2a and 2b have functions to supply exhaust gas generated in the exhaust gas generating section to the combustion chamber 1. The same kind of exhaust gas may be supplied from the same or different exhaust gas generating sections to the exhaust gas supply passages 2a and 2b, or different kinds of exhaust gas may selectively be supplied from different exhaust gas generating section to the exhaust gas supply passages 2a and 2b.

Temperature sensors 11b and 11c are provided at predetermined positions of the exhaust gas supply passages 2a and 2b. The temperature sensors 11b and 11c always monitors the temperatures of the exhaust gas supply passages 2a and 2b, thereby monitoring the exhaust gas introducing temperature and monitoring generation of backfire phenomenon.

Each of the burners 3 selectively supplies hydrogen gas, LNG (natural gas) LPG (liquefied petroleum gas), manufactured gas and the like, ignites the selected reaction facilitating gas, thereby forming flame, and this flame heats the exhaust gas to high temperature.

The combustion gas transfer passage 4 allows waste gas which burned in the combustion chamber 1 to flow, and allows a scraper (not shown) which is continuously provided at downstream 4d from the combustion gas transfer passage of the combustion gas transfer passage 4 to suck the waste gas. A temperature sensor 1d is provided in the combustion gas transfer passage 4 downstream from the combustion chamber 1.

As shown in FIGS. 1 and 2, the scraper 7 which is a scraping member includes a lever 7a which is disposed adjacent to an inner wall of the combustion chamber 1 comprising the cylindrical bodies 1a and 1b and whose one portion is in contact with the inner wall, a support member 7c which supports the lever 7a and whose one portion is in contact with the inner wall of the lid body 10, a reinforcing member 7b which reinforces a joint portion between the lever 7a and the support member 7c, a shaft 7d which is mounted on the support member 7c and which penetrates the lid body 10, and a handle 7e mounted on the shaft 7d.

The shaft 7d is rotatably supported by a bearing 5 provided on the lid body 10 in a state in which air-tightness is maintained.

Therefore, scraper 7 has a construction as follows. One end of the lever 7 of the scraper 7 is formed as a free end. The other end of the lever 7 is connected to the shaft 7d by means of the support member 7c. One end of the shaft 7d operates the handle 7e which is a driving member provided outside of the combustion chamber 1. With this, it is rotated, and a blade portion of the lever 7a or an acute edge portion 7a1 comes into contact with inner surfaces of the cylindrical bodies 1a and 1b constituting the combustion chamber 1 in the circumferential direction and moves, and scraps off the powder attached to the inner surfaces of the cylindrical bodies 1a and 1b constituting the combustion chamber 1, the blade portion of the support member 7c or the acute edge portion 7c1 comes into contact with the inner surface of the lid body 10 constituting the combustion chamber 1 in the circumferential direction and moves, and scrapes the powder attached to the inner surface of the lid body 10 constituting the combustion chamber 1.

A blade portion or edge portions 7a1 and 7c1 are provided at positions opposed to the inner surface of the lever 7a and the combustion chamber 1 of the support member 7c. With this, powder attached to the inner wall surfaces of the cylindrical bodies 1a and 1b and the inner wall surface of the lid body 10 can be scraped off effectively.

As shown in FIG. 3, a scoop angle r of the blade portion of the lever 7a or the cylindrical bodies 1a and 1b of the acute edge portion 7a1 with respect to the inner peripheral surfaces of the cylindrical bodies 1a and 1b (i.e., angle formed between a straight line b, which is perpendicular to a straight line a connecting the rotation center of the shaft 7d and the tip end of the blade portion of the lever 7a or the tip end of the acute edge portion 7a1, and a straight line c of the extension of the surface of the blade portion or the acute edge portion 7a1) is preferably 30° and less than 90°.

It is preferable that the relief angle of the lever 7a (i.e., angle formed between a bottom surface of the lever 7a and the straight line b) β is 1° or greater and 30° or smaller, and more preferably 1° or greater and 15° or smaller. In this embodiment, the relief angle β of the lever 7a is set to about 15°.

Thus, an inclination angle α of the blade portion of the lever 7a or the acute edge portion 7a1 is 30° or greater and 60° or smaller.

It is preferable that the distance between the blade portion of the lever 7a or the tip end of the acute edge portion 7a1 and inner peripheral surfaces of the cylindrical bodies 1a and 1b constituting the combustion chamber 1 is 1 mm or greater and 10 mm or smaller. The distance between the blade portion of the support member 7c and the tip end of the acute edge portion 7c1 and an inner surface of the lid body 10 constituting the combustion chamber 1 is 3 mm or greater and 13 mm or smaller.

For example, when the lever 7a simply comprises a flat bar, a surface thereof which scrapes off the powder attached to the inner surfaces of the cylindrical bodies 1a and 1b is substantially perpendicular to the inner surfaces of the cylindrical bodies 1a and 1b. Thus, the powder can not effectively be scraped off, and power which escaped from a leading angle of the flat bar is pushed against the cylindrical bodies 1a and 1b or the inner surface of the lid body 10 by a lever action of the subsequent angle portion, and the powder is attached to the inner surfaces in some cases.

In this embodiment, the blade portion or the acute edge portions 7a1 and 7c1 are provided at positions of the lever 7a and the support member 7c constituting the scraping member which are opposed to the inner surfaces of the cylindrical bodies 1a and 1b and the lid body 10, and the lever 7a is provided with the relief angle β. With this configuration, the scoop angle γ in which the blade portion of the lever 7a or the acute edge portion 7a1 scrapes the powder can be set to an acute angle with respect to the combustion chamber 1 and the inner surface of the lid body 10 and with this, the powder attached to the inner surface of the combustion chamber 1 can effectively be scraped off by the lever 7a and the support member 7c to clean the inside of the combustion chamber 1. Further, the power escaping from the lever 7a is not pushed against and strongly attached to the inner surfaces of the cylindrical bodies 1a and 1b by the lever action by means of the relief angle β provided on the lever 7a, and hard powder can be scraped off by the plane effect.

Main objects which attach to the inner surface of the combustion chamber 1 is power as combustion product which is produced when exhaust gas to be processed is burned. This power is extremely fine in particle diameter, and most of powder passes through the combustion gas transfer passage 4 together with waste gas generated after combustion and is collected in the scrubber (not shown). However, when the powder floats and falls in the combustion chamber 1, powder is attached to the inner surface of the combustion chamber 1 and the lever 7a of the scraper 7.

Therefore, the scraper 7 has a function to scrape off the powder attached to the inner surface of the combustion chamber 1. By operating the scraper 7, it is possible to always keep the inner surface of the combustion chamber 1 clean.

Thus, the lever 7a is formed longer than the cylindrical bodies 1a and 1b. At least one of the cylindrical bodies 1a and 1b constitutes the combustion chamber 1. The end of the lever 7a projects from the combustion chamber 1 into the combustion gas transfer passage 4.

The lever 7a and the support member 7c should be made of heatproof steel from which the blade portion or the acute edge portions 7a1 and 7c1 can be made. The blade portion or the acute edge portions 7a1 and 7c1 can endure high temperature and have excellent corrosion resistance, and reliably comes into contact with the inner surface of the combustion chamber 1 to scrape off the attachment of the inner wall. For example, it is preferable that heatproof alloy such as Inconel (tradename of INCO) is employed.

The lever 7a and the reinforcing member 7b may be made of Inconel, and the support member 7c may be made of stainless steel such as SUS304.

The impact member 8 shown in FIG. 1 generates an impact against the lever 7a so as to scrape off the powder attached to the lever 7a constituting the scraper 7. Thus, the impact member 8 should exhibit this function and its configuration is not especially limited.

As shown in FIG. 4, the impact member 8 of this embodiment comprises a leaf spring 8a provided at a position where the leaf spring 8a can come into contact with a free end of the lever 7a of the scraper 7, and pairs of leaf springs 8b and 8c having a step therebetween. The leaf spring 8a and the leaf springs 8b and 8c are overlapped on one another.

For example, the impact member 8 shown in FIG. 4 fixes a holder 8d at a predetermined position of the T-type cylindrical body 4a constituting the combustion gas transfer passage 4, the leaf springs 8a, 8b and 8c which are overlapped on one another with steps are set along the holder 8d, and a tip end of the central leaf spring 8a projects from the inner surface of the combustion chamber 1 by an appropriate length, and the bunch of the leaf springs 8a, 8b and 8c is fixed by a presser plate 8e.

According to the impact member 8, if the scraper 7 is rotated and the lever 7a abuts against the leaf spring 8a, subsequent rotation of the scraper 7 allows the lever 7a to bend the leaf springs 8b and 8c located downstream from the leaf spring 8a and the lever 7a in the rotation direction as shown with phantom lines, and bending 6 is generated in the circumferential direction as shown with phantom line.

As the scraper 7 further rotates, the bending of each of the leaf springs 8a, 8b and 8c is increased, and the contact with the leaf spring 8a and the lever 7a is released. At that time, the leaf springs 8a, 8b and 8c and the lever 7a return to their original shapes, but an impact is generated against the lever 7a when the bending 6 is instantaneously returned, the lever 7a is vibrated and powder attached to the lever 7a can be scraped off.

With the above configuration, by overlapping the leaf springs 8a, 8b and 8c with steps which can bend the lever 7a when they come into contact with the lever 7a and which can generate the impact as the lever 7a is returned to its original shape when the contact is released, the stress applied to the leaf springs 8a, 8b and 8c can be made surface contact and with this, the stress applied to the leaf springs 8a, 8b and 8c can be moderated and the bending can be prevented, and the lifetime of the impact member 8 can be increased.

The position of the impact member 8 is not especially limited, and the impact member 8 may be provided downstream from the combustion gas transfer passage 4 in the flowing direction (downstream in the direction from the upstream from the combustion gas transfer passage toward the downstream from the combustion gas transfer passage).

According to the exhaust gas processing apparatus A having the above-described configuration, if the scrubber (not shown) connected to a downstream side from the combustion gas transfer passage 4 is operated, exhaust gas to be processed is supplied from the exhaust gas supply passages 2a and 2b to the combustion chamber 1 by suction effect of the scrubber, and exhaust gas flows toward the combustion gas transfer passage 4 in the combustion chamber 1. At the same time, air in the casing 9 flows from the upstream side 4c of the combustion gas transfer passage 4 to the downstream side 4d.

The flame ignited by the burner 3 decomposes and burns the exhaust gas supplied from the exhaust gas supply passages 2a and 2b to the combustion chamber 1 at high temperature, and the combustion gas flows to the combustion gas transfer passage 4. At that time, powder is generated as combustion product, and most of the powder flows into the combustion gas transfer passage 4 and is discharged together with waste gas which is generated when the exhaust gas is decomposed and burned. The waste gas and powder which flowed into the combustion gas transfer passage 4 flows in the direction shown with arrows in FIG. 1 and powder is caught by the scrubber (not shown). A portion of powder generated in the combustion chamber 1 scatters and attach to the inner surface of the combustion chamber 1 and the lever 7a of the scraper 7.

Thus, the handle 7e of the scraper 7 is operated periodically, and powder attached to the inner surface of the combustion chamber 1 is scraped off by the lever 7a and the blade portion provided on the support member 7c or the acute edge portions 7a1 and 7c1, the lever 7a is allowed to come into contact with the impact member 8 to generate an impact against the lever 7a, thereby scraping off the powder which attached to the lever 7a. Power which was scraped off is sucked and collected by the scrubber (not shown) from the combustion chamber 1 through the combustion gas transfer passage 4 by the suction effect of the scrubber (not shown).

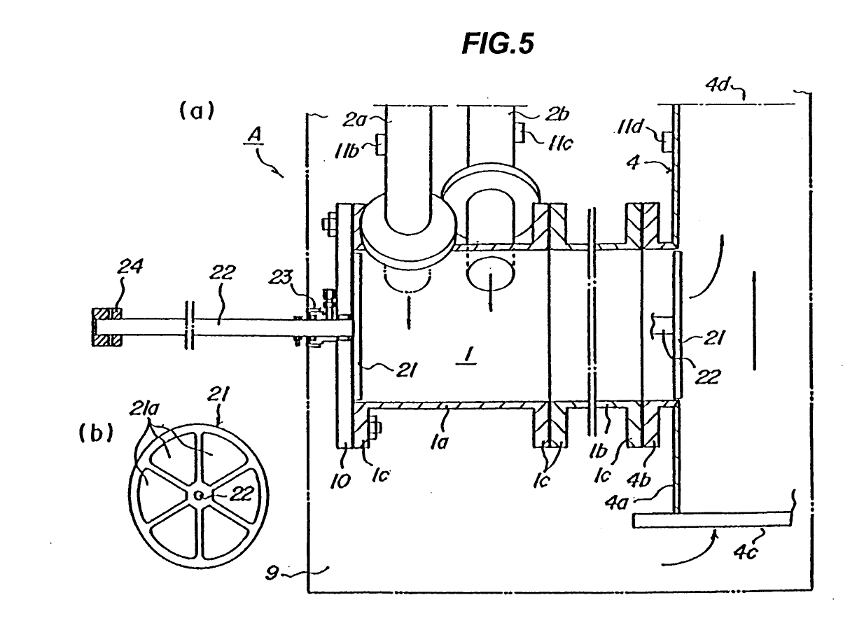

Next, a second embodiment of the exhaust gas processing apparatus according to the present invention will be explained using FIG. 5. FIG. 5 is a perspective explanatory view showing a configuration of the second embodiment of the exhaust gas processing apparatus of the invention. The same members as those of the first embodiment are designated with the same symbols, and explanation thereof is not repeated.

In FIG. 5, the scraping member of this embodiment includes an annular member 21 which can move in a direction (lateral direction in FIG. 5(a)) in which exhaust gas flows through the combustion chamber 1 along the inner peripheral surfaces of the cylindrical bodies 1a and 1b which constitute the combustion chamber 1 as shown in FIG. 5(a). The burner 3 and the like are mounted on the cylindrical body 1b like the first embodiment, but these members are omitted in FIG. 5.

The annular member 21 has an outer diameter corresponding to inner diameters of the cylindrical bodies 1a and 1b constituting the combustion chamber 1. As shown in FIG. 5(b), a shaft 22 is fixed to a center of the diameter. A predetermined number of vent holes 21a are formed at predetermined positions. The shaft 22 can rotate and move in the lateral direction in FIG. 5(a) in a state in which the air-tightness is maintained by a bearing 23 provided on the lid body 10.

The end of the shaft 22 is provided with a handle 24 which is a driving member provided outside the combustion chamber 1. By operating the handle 24 to move the annular member 21 which is integrally fixed to the shaft 22 in the lateral direction shown in FIG. 5(a) along the inner surfaces of the cylindrical bodies 1a and 1b which constitute the combustion chamber 1, the power attached to the inner surface of the combustion chamber 1 can be scraped off.

In a normal using state, the annular member 21 is retracted into the connected flange 1c which abuts against the lid body 10 and is connected thereto. An operator grasps the handle 24 at the time of cleaning of the combustion chamber 1, moves the combustion chamber 1 in the lateral direction and scraps off the powder attached to the inner wall of the combustion chamber 1.

In this embodiment, the operator taps the end of the handle 24 with a hammer or the like to push the annular member 21 in the right direction in FIG. 5(a), thereby removing the powder strongly attached to the inner surfaces of the cylindrical bodies 1a and 1b.

The shaft 22 may comprises a screw, the bearing 23 is provided with a female screw corresponding to the former screw, the shaft 22 is rotated by a motor (not shown) so that the annular member 21 is automatically moved in the lateral direction in FIG. 5(a).

According to this configuration, the annular member 21 which is the scraping member operates the handle 24 which is a driving member provided outside of the combustion chamber 1, the combustion chamber 1 can move along the inner surface of the combustion chamber 1 in the direction in which the exhaust gas flows, the annular member 21 which is the scraping member can reliably come into contact with the inner surface of the combustion chamber 1 in the direction in which the exhaust gas flows through the combustion chamber 1 and the powder can be scraped off, powder strongly attached to the inner surface of the combustion chamber 1 can easily be scraped off and removed. Other configurations are the same as those of the first embodiment, and the same effect can be obtained.

### INDUSTRIAL APPLICABILITY

According to the present invention, powder attached to the inner wall of the combustion chamber is scraped off by the scraping member and the flame of the burner can completely be discharged into the combustion chamber from the exit, and the invention can be used for enhancing the combustion efficiency.

Since the blade portion or the acute edge portion is provided on the lever constituting the scraping member at the position opposed to the inner surface of the combustion chamber, the surface which scrapes off the powder forms the acute angle with respect to the inner surface of the combustion chamber. With this, powder attached to the inner surface of the combustion chamber can effectively be scraped off by the scraping member, and the invention can be used for cleaning the inside of the combustion chamber.

The invention has the impact member for generating an impact against the scraping member. The plurality of leaf springs are overlapped on one another with steps therebetween, and the leaf spring can generate an impact as the impact member bends the lever when the impact member comes into contact with the lever and the lever is returned to its original shape when the contact is released. With this configuration, the stress applied to the leaf spring can be made the surface contact, the stress applied to the leaf spring can be moderated to prevent the straight line from being folded, and the invention can be used for increasing the lifetime of the impact member.

If the scraping member is provided such that the scraping member can move in the direction in which the exhaust gas flows through the combustion chamber along the inner surface of the combustion chamber by the driving member provided outside of the combustion chamber, the scraping member can reliably scrape the powder in the direction in which the exhaust gas flows through the combustion chamber in the state in which the scraping member is in contact with the combustion chamber, and the powder strongly attached to the inner surface of the combustion chamber can easily be scraped off and removed.

1. An exhaust gas processing apparatus comprising a combustion chamber and a combustion gas transfer passage, in which one end of the combustion chamber is closed and the other end thereof is connected to the combustion gas transfer passage, an exhaust gas supply passage is disposed on the side of the closed end, a burner is disposed closer to the combustion gas transfer passage than the exhaust gas supply passage, exhaust gas supplied to the combustion chamber is heated to a high temperature and decomposed or burned, and the exhaust gas is discharged from the combustion gas transfer passage, wherein
the exhaust gas processing apparatus further comprises a scraping member which moves in a circumferential direction along an inner surface of the combustion chamber to scrapes off powder which is attached to the inner surface of the combustion chamber, the scraping member comprises a lever whose one end of the scraping member is mounted on a driving member provided outside of the combustion chamber and the other end is formed as a free end, a blade portion or an acute edge portion is provided on the lever at a position opposed to the inner surface of the combustion chamber.

2. The exhaust gas processing apparatus according to claim 1, further comprising an impact member for generating an impact against the scraping member, and a plurality of leaf springs overlapped on one another with steps therebetween for generating an impact as the impact member bends the lever when the impact member comes into contact with the lever and the lever is returned to its original shape when the contact is released.

3. An exhaust gas processing apparatus comprising a combustion chamber and a combustion gas transfer passage, in which one end of the combustion chamber is closed and the other end thereof is connected to the combustion gas transfer passage, an exhaust gas supply passage is disposed on the side of the closed end, a burner is disposed closer to the combustion gas transfer passage than the exhaust gas supply passage, exhaust gas supplied to the combustion chamber is heated to a high temperature and decomposed or burned, and the exhaust gas is discharged from the combustion gas transfer passage, wherein
the exhaust gas processing apparatus further comprises a scraping member for scraping off powder attached to an inner surface of the combustion chamber, the scraping member can move in a direction in which the exhaust gas flows through the combustion chamber along the inner surface of the combustion chamber by a driving member provided outside of the combustion chamber.
